(19) United States
(12) Patent Application Publication
(10) Pub. No.: US 2022/0043325 A1
(43) Pub. Date: Feb. 10, 2022

(54) LIGHT-SHIELDING SHEET AND OPTICAL LENS HAVING LIGHT-SHIELDING SHEET

(71) Applicant: HON HAI PRECISION INDUSTRY CO., LTD., New Taipei (TW)

(72) Inventors: JEN-HUNG HUANG, New Taipei (TW); CHUN-CHENG KO, New Taipei (TW)

(21) Appl. No.: 17/108,148

(22) Filed: Dec. 1, 2020

(30) Foreign Application Priority Data
Aug. 6, 2020 (CN) 202010781348.4

(51) Int. Cl. G03B 17/12; G02B 7/02; G02B 7/20

(52) U.S. Cl. CPC G03B 17/12; G02B 7/20; G02B 7/026

(57) ABSTRACT

A light-shielding sheet includes a base defining a first through hole and a second through hole. The first through hole and the second through hole are arranged coaxially in the base. A diameter of the first through hole is smaller than a diameter of the second through hole. The base is provided with a light-shielding coating covering an inner wall of the first through hole and the second through hole. When an incident light angle θ is between 45° and 55°, a following relationship is satisfied: 0.01≤W≤0.02; 3≤D≤3.5; 0.0122≤W/sinθ≤0.0283. W denotes a thickness of the base W, and D denotes the diameter of the first through hole.

### FIELD

The subject matter herein generally relates to optical lenses, and more particularly to a light-shielding sheet of an optical lens.

### BACKGROUND

An optical lens generally includes a lens and a light-shielding sheet. The light-shielding sheet is an optical element used to control the amount of light in an optical system. When external light enters the lens, the light-shielding sheet can block stray light. However, due to structural characteristics of the light-shielding sheet, when light at a specific incident light angle irradiates a side wall of a through hole of the light-shielding sheet, reflection or diffuse reflection will occur at the inner wall, which will interfere with the optical system and produce stray light spots, which negatively affects an imaging quality of the optical lens.

### BRIEF DESCRIPTION OF THE DRAWINGS

Implementations of the present disclosure will now be described, by way of embodiments, with reference to the attached figures.

FIG. 1 is a schematic perspective diagram of an embodiment of a light-shielding sheet.

FIG. 2 is a cutaway view of the light-shielding sheet in FIG. 1.

FIG. 3 is an enlarged view of circled portion III in FIG. 2.

FIG. 4 is a cross-sectional diagram of the light-shielding sheet according to an embodiment.

FIG. 5 is a cross-sectional diagram of an embodiment of an optical lens.

FIG. 6 is a picture taken with an optical lens in the related art.

FIG. 7 is a picture taken with an optical lens provided by an embodiment of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

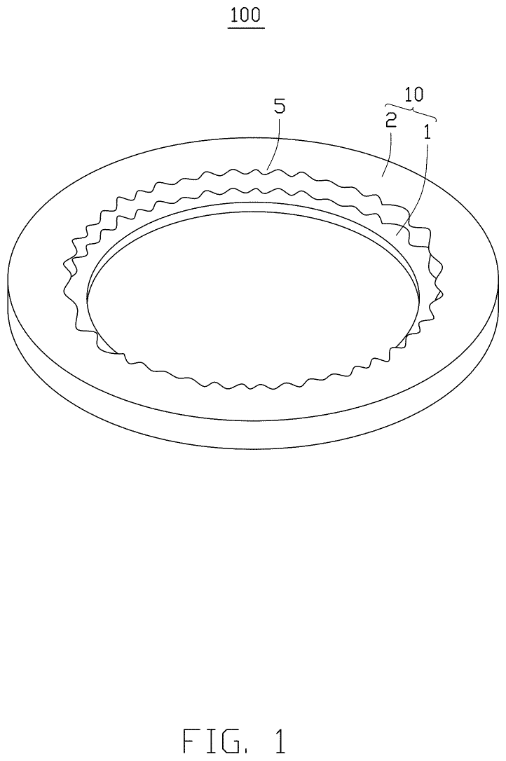

FIGS. 1-4 show an embodiment of a light-shielding sheet 100. The light-shielding sheet 100 includes a base 10. A first through hole 3 and a second through hole 4 are defined coaxially in the base 10. A diameter of the first through hole 3 is smaller than a diameter of the second through hole 4. A surface of the base 10 is provided with a light-shielding coating 6 covering inner walls of the first through hole 3 and the second through hole 4.

A thickness of the base 10 has an important effect on whether stray light can form a spot that affects a quality of an optical lens. Normally, when an incident light angle is within a range from 0° to 45°-55°, the light-shielding sheet 100 will form stray light spots that affect a light shooting effect. When a thickness of the base 10 is W and a diameter of the first through hole 3 is D, the following relationship needs to be satisfied for the incident light angle so that stray light spots that affect the quality of the optical lens will not be formed: 0.01≤W≤0.02; 3≤D≤3.5; 0.0122≤W/sinθ≤0.0283.

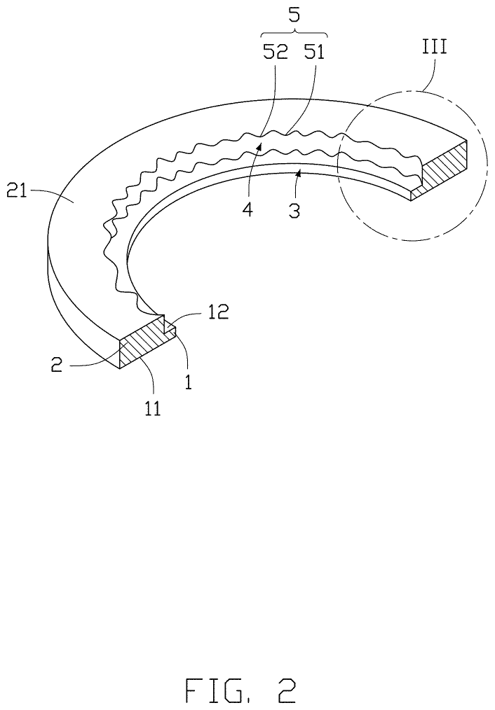

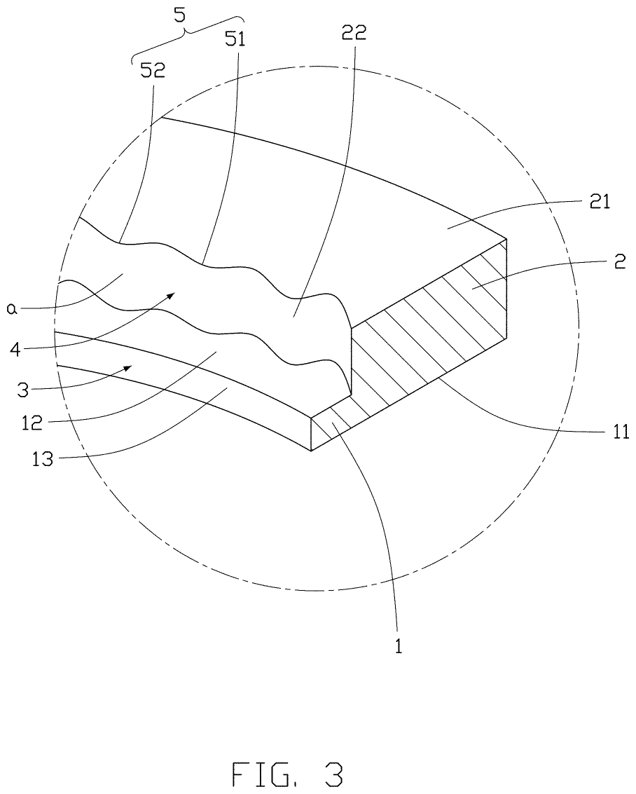

As shown in FIGS. 2 and 3, the base 10 includes a first body 1 and a second body 2 that are stacked. The first through hole 3 is defined in the first body 1. The first body 1 includes a first surface 11, a second surface 12, and a first side wall 13. The second surface 12 is opposite the first surface 11, and the first side wall 13 is a side wall of the first through hole 3. The second through hole 4 is defined in the second body 2.

The second body 2 includes a third surface 21 and a second side wall 22. The second side wall 12 is a side wall of the second through hole 4.

A plurality of microstructures 5 is formed on the second side wall 22. The light-shielding coating 6 is covered on the first surface 11, the second surface 12, the third surface 21, the first side wall 13, and the microstructure 5.

In one embodiment, the first body 1 and the second body 2 are integrally formed, and the first through hole 3 and the second through hole 4 are coaxially defined. The inner diameter D of the first through hole 3 is smaller than the inner diameter of the second through hole 4, so that a step is formed at an interface between the first through hole 3 and the second through hole 4. The step can suppress stray light reflection or diffuse reflection in the optical lens to an imaging surface, thereby ensuring a shooting effect and improving a quality of a captured image.

In one embodiment, a width of the second surface 12 is 0.1 mm to 0.5 mm, and the light-shielding coating 6 is provided on the second surface 12 to enhance an effect of eliminating stray light spots.

In one embodiment, the first body 1 and the second body 2 are made of plastic, such as polyethylene terephthalate (PET) or other materials.

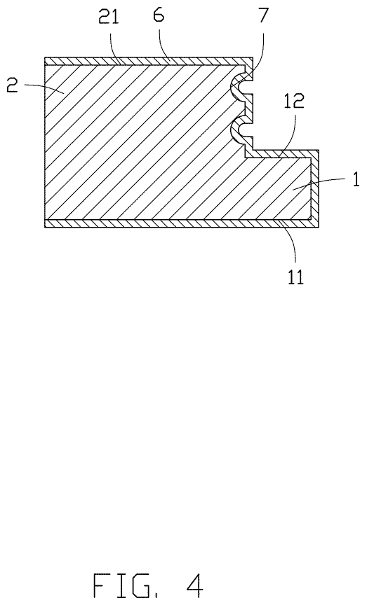

As shown in FIGS. 3 and 4, a shape of the microstructure 5 may be one or more of an arcuate structure, a zigzag structure, a recessed structure, or other shaped structures so that a path of light reflection is changed to prevent stray light rays from entering the imaging surface. In addition, a design of the microstructures 5 can increase a light receiving area, increase absorption of stray light, and improve an extinction effect of stray light.

As shown in FIG. 3, in one embodiment, the microstructures 5 are arcuate structures formed by portions of the second side wall 22 extending toward a central axis of the second through hole 4. A vertex a of the microstructures 5 is located on the second surface 12, that is, the microstructures do not extend beyond an edge of the second surface 12 adjacent to the first through hole 3. The microstructures 5 include first arcuate portions 51 and second arcuate portions 52. The first arcuate portions 51 and the second arcuate portions 52 may be arranged regularly or randomly. In one embodiment, the first arcuate portions 51 and the second arcuate portions 52 are alternately arranged. In another embodiment, the first arcuate portions 51 and the second arcuate portions 52 may be alternately arranged in duplicate, triplicate, or the like.

In one embodiment, a radius of curvature of the first arcuate portions 51 is greater than or equal to a radius of curvature of the second arcuate portions 52. In other embodiments, the radius of curvature of each of the first arcuate portions 51 and each of the second arcuate portions 52 may be different for changing a propagation path of light in different directions.

In one embodiment, the microstructures 5 and the second body 2 are integrally formed, and the microstructures 5 may be formed on the second side wall 22 by etching. By etching, the vertex a of the microstructure 5 will not extend beyond the edge of the second surface 12 adjacent to the first through hole 3, so that the step and the microstructures 5 cooperatively change the propagation path of the stray light, thereby preventing the stray light from entering the imaging surface, improving the extinction efficiency of the stray light, and improving the quality of the captured image.

As shown in FIG. 4, in another embodiment, microstructures 7 may be a plurality of recessed structures formed on the inner wall of the second through hole 4 by etching.

In one embodiment, the light-shielding coating 6 is a black light-shielding ink layer, which has light-shielding and matting functions. For example, the light-shielding coating 6 may be a light-shielding ink with carbon black.

A method for manufacturing the light-shielding sheet 100 may include the following steps.

In a first step, the base 10 is provided in which the first through hole 3 and the second through hole 4 are defined by a punching process. A diameter of the first through hole 3 is smaller than the diameter of the second through hole 4, thereby forming a step.

In a second step S2, the second side wall 22 of the second through hole 4 is etched to form the plurality of microstructures 5.

In a third step, the light-shielding coating 6 is sprayed on upper and lower surfaces (the first surface 11 and the third surface 21) of the base 10 by an ink sprayer.

The light-shielding coating 6 may be a light-shielding ink, and the light-shielding ink flows toward the first through hole 3 and the second through hole 4, so that the light-shielding ink covers surfaces of the first through hole 3 and the second through hole 4, and then the light-shielding ink is cured to form the light-shielding coating.

In the second step S2, the microstructure 5 may be formed by the following process.

First, a film is attached to the second side wall 22 and an edge of the third surface 21 adjacent to the second through hole 4. The film on the edge of the third surface 21 is pre-processed into a shape consistent with a shape of the microstructures 5.

After the film is attached, a layer of anti-corrosion coating is sprayed onto the first surface 11, the second surface 12, a portion of the third surface 21 not attached by the film, and the first side wall 13.

Then, the film is removed, and the light-shielding sheet is placed into an etching solution for etching. The etching solution may be an etching solution that corrodes the base 10 but not the anti-corrosion coating, or may be an etching solution that corrodes the anti-corrosion coating at a rate less than a rate of corroding the base 10.

After etching is finished, the light-shielding sheet is taken out of the etching solution and washed and dried.

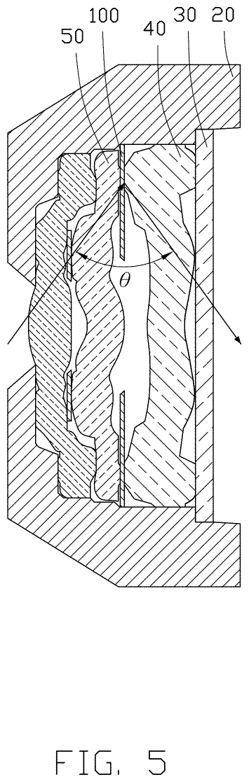

FIG. 5 shows an embodiment of an optical lens 200, which includes a lens barrel 20, a pressing ring 30, a lens 40, the light-shielding sheet 100, and a spacer 50. The pressing ring 30, the lens 40, the light-shielding sheet 100, and the spacer 50 are housed in the lens barrel 20. The light-shielding sheet 100 is located between the lens 40 and the spacer 50.

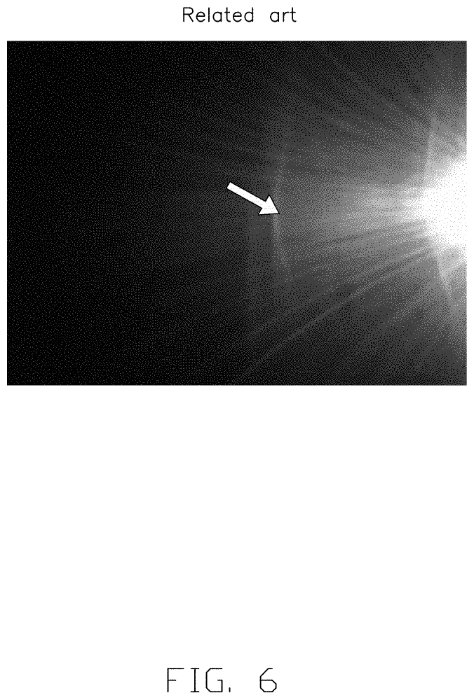

FIG. 6 shows a picture taken by an optical lens in the related art. An area indicated by the arrow in FIG. 6 is a stray light spot.

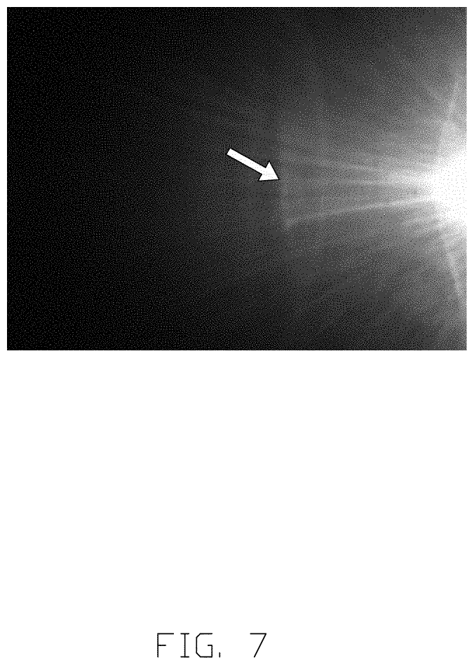

FIG. 7 is a picture taken by the optical lens 200 with the light-shielding film 100. A thickness of the light-shielding sheet 100 has an important effect on whether stray light can form a spot that affects the quality of the optical lens. The thickness of the light-shielding sheet 100 is W, the diameter of the first through hole 3 is D, and the incident light angle is θ. Normally, the incident light angle θ is in the range of 45°-55°. The following relationship is satisfied for the incident light angle so that stray light spots that affect the quality of the optical lens are not formed: 0.01≤W≤0.02; 3≤D≤3.5; 0.0122<W/sinθ≤0.0283. It can be seen in FIG. 7 that the stray light spots in the area indicated by the arrow are effectively reduced.

The optical lens 200 is suitable to be applied in most products with lenses, such as mobile phones, notebook computers, desktop computers, game consoles, TVs, and so on.

Compared with the related art, the light-shielding sheet 100 has the following beneficial effects.

1. The thickness and diameter of the light-shielding sheet is designed according to the specific incident light angle, which is more effective to prevent the formation of stray light spots.

2. A step is formed at the interface between the first through hole and the second through hole. The step design can suppress stray light reflection or diffuse reflection in the optical lens to the imaging surface, thereby ensuring the shooting effect and improving the quality of the captured image.

3. The design of the microstructures changes the path of light reflection, so as to prevent stray light rays from entering the imaging surface. In addition, the microstructure design can also increase the light receiving area and increase the absorption of stray light.

4. The light-shielding coating is not only applied on the upper and lower surfaces of the light-shielding sheet, but also on the surfaces of the first through hole and the second through hole and the surfaces of the microstructures, which can effectively prevent stray light rays from entering the imaging surface of the optical lens.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A light-shielding sheet comprising:
a base defining a first through hole and a second through hole, the first through hole and the second through hole arranged coaxially in the base, and a diameter of the first through hole being smaller than a diameter of the second through hole, wherein:
the base is provided with a light-shielding coating covering an inner wall of the first through hole and the second through hole;
when an incident light angle θ is between 45° and 55°, a following relationship is satisfied: 0.01≤W≤0.02; 3≤D≤3.5; 0.0122≤W/sinθ≤0.0283; and
wherein W denotes a thickness of the base, and D denotes the diameter of the first through hole.

2. The light-shielding sheet of claim 1, wherein:
the base comprises a first body and a second body that are stacked;
the first through hole is defined in the first body;
the first body comprises a first surface, a second surface, and a first side wall;
the second surface is opposite the first surface, and the first side wall is a side wall of the first through hole;
the second through hole is defined in the second body;
the second body comprises a third surface and a second side wall;
the second side wall is a side wall of the second through hole; and
a plurality of microstructures is provided on the second side wall.

3. The light-shielding sheet of claim 2, wherein:
a shape of the microstructures is one or more of an arcuate structure, a zigzag structure, or a recessed structure.

4. The light-shielding sheet of claim 3, wherein:
the shape of the microstructures is the arcuate structure;
the microstructures comprise first arcuate portions and second arcuate portions; and
at least one of the first arcuate portions and at least one of the second arcuate portions are arranged adjacently.

5. The light-shielding sheet of claim 4, wherein:
a radius of curvature of the first arcuate portions is greater than or equal to a radius of curvature of the second arcuate portions.

6. The light-shielding sheet of claim 5, wherein:
the light-shielding coating covers surfaces of the microstructures.

7. The light-shielding sheet of claim 2, wherein:
the first body and the second body are integrally formed; and the microstructures and the second body are integrally formed.

8. The light-shielding sheet of claim 2, wherein:
a width of the second surface is 0.1 mm to 0.5 mm.

9. The light-shielding sheet of claim 1, wherein:
the light-shielding coating is formed from a black shading ink.

10. An optical lens comprising:
a lens barrel;
a pressing ring housed in the lens barrel;
a lens housed in the lens barrel;
a spacer housed in the lens barrel; and
a light-shielding sheet housed in the lens barrel and located between the lens and the spacer, the light-shielding sheet comprising:
a base defining a first through hole and a second through hole, the first through hole and the second through hole arranged coaxially in the base, and a diameter of the first through hole being smaller than a diameter of the second through hole, wherein:
the base is provided with a light-shielding coating covering an inner wall of the first through hole and the second through hole;
when an incident light angle θ is between 45° and 55°, a following relationship is satisfied: 0.01≤W≤0.02; 3≤D≤3.5; 0.0122≤W/sinθ≤0.0283; and
wherein W denotes a thickness of the base, and D denotes the diameter of the first through hole.

11. The optical lens of claim 10, wherein:
the base comprises a first body and a second body that are stacked;
the first through hole is defined in the first body;
the first body comprises a first surface, a second surface, and a first side wall;
the second surface is opposite the first surface, and the first side wall is a side wall of the first through hole;
the second through hole is defined in the second body;
the second body comprises a third surface and a second side wall;
the second side wall is a side wall of the second through hole; and
a plurality of microstructures is provided on the second side wall.

12. The optical lens of claim 11, wherein:
a shape of the microstructures is one or more of an arcuate structure, a zigzag structure, or a recessed structure.

13. The optical lens of claim 12, wherein:
the shape of the microstructures is the arcuate structure;
the microstructures comprise first arcuate portions and second arcuate portions; and
at least one of the first arcuate portions and at least one of the second arcuate portions are arranged adjacently.

14. The optical lens of claim 13, wherein:
a radius of curvature of the first arcuate portions is greater than or equal to a radius of curvature of the second arcuate portions.

15. The optical lens of claim 14, wherein:
the light-shielding coating covers surfaces of the microstructures.

16. The optical lens of claim 15, wherein:
the first body and the second body are integrally formed; and
the microstructures and the second body are integrally formed.

17. The optical lens of claim 16, wherein:
a width of the second surface is 0.1 mm to 0.5 mm.

18. The optical lens of claim 17, wherein:
the light-shielding coating is formed from a black shading ink.
